(19) United States
(12) Patent Application Publication
(10) Pub. No.: US 2025/0313052 A1
(43) Pub. Date: Oct. 9, 2025

(54) SUSPENSION SYSTEM WITH HOLD CONTROL

(71) Applicant: JAGUAR LAND ROVER LIMITED, Whitley, Coventry, Warwickshire (GB)

(72) Inventors: David RUIZ DIEZ, Whitley, Coventry, Warwickshire (GB); Jack WRIGHT, Whitley, Coventry, Warwickshire (GB)

(21) Appl. No.: 18/862,901

(22) PCT Filed: May 4, 2023
(86) PCT No.: PCT/EP2023/061800

§ 371 Date: Nov. 4, 2024

(30) Foreign Application Priority Data
May 5, 2022 (GB) 2206587.4

(51) Int. Cl. B60G 17/016; B60G 17/019; B60G 17/052

(52) U.S. Cl. CPC B60G 17/0164; B60G 17/01908; B60G 17/052; B60G 2400/104; B60G 2400/106; B60G 2400/34; B60G 2400/41; B60G 2500/22; B60G 2600/07

(57) ABSTRACT

Aspects relate to control systems for an air spring of a suspension system of a vehicle. The control system is configured to, when the air spring is operating in a high stiffness state during vehicle motion, receive a signal indicative of a rate of change of acceleration of the vehicle. The control system is configured to determine if a spring state hold condition is satisfied in dependence on the rate of change of acceleration. If the spring state hold condition is determined to be satisfied, the control system is configured to output a hold control signal to cause the air spring to remain operating in the high stiffness state.

### CROSS REFERENCE TO RELATED APPLICATIONS

The present application is a U.S. National Phase of International Application No. PCT/EP2023/061800 entitled “SUSPENSION SYSTEM WITH HOLD CONTROL,” and filed on May 4, 2023. International Application No. PCT/EP2023/061800 claims priority to Great Britain Patent Application No. 2206587.4 filed on May 5, 2022. The entire contents of each of the above-listed applications are hereby incorporated by reference for all purposes.

### TECHNICAL FIELD

The present disclosure relates to a suspension system with hold control to cause a variable stiffness spring, such as a variable volume air spring, to remain operating in a high stiffness state. Aspects relate to control system, to a system, to a method of operating the control system, to computer software and to a non-transitory, computer-readable storage medium.

### BACKGROUND

Vehicles typically comprise active suspension systems for maintaining vehicle stability. Some active suspension systems have variable stiffness springs, such as adaptive air springs, also known as additional switchable volume (ASV) air springs. Such variable stiffness springs can provide different spring stiffness states. The air spring may be controlled by a control system which sends switching signals to a valve of the air spring to open or close air chambers within the air spring and change the air volume, and thus the spring stiffness. The switching command may be sent based upon measured acceleration values reaching a particular threshold value, for example.

However, if the acceleration of the vehicle is discontinuous, or changes often between values crossing the switching thresholds such as during dynamic driving conditions, the air springs may switch between high and low stiffness states repeatedly. This may lead to an uncomfortable driving experience. Each time the switch is made, the mechanical components controlling the operative air volume must operate, and thus the more often the spring stiffness is changed, the quicker mechanical wear and tear may take effect. Furthermore, operating a valve control system in this way may be computationally expensive, as acceleration is measured using an accelerometer, and so the control system must process a large quantity of data to continuously manage the spring operation according to the received acceleration values. Also, anomalous data points may cause false indications that a threshold has been passed, and so the air springs may be controlled to switch stiffness state at an inopportune moment.

It would therefore be advantageous to provide a control system which overcomes at least some of these disadvantages.

### SUMMARY OF THE INVENTION

Aspects and embodiments of the invention provide a control system, a system, a method, computer software and a non-transitory, computer-readable storage medium as claimed in the appended claims.

According to a first aspect of the invention there is provided a control system for an air spring of a suspension system of a vehicle, the control system comprising one or more controllers, the control system configured to: when the air spring is operating in a high stiffness state during vehicle motion, receive a signal indicative of a rate of change of acceleration of the vehicle; determine if a spring state hold condition is satisfied in dependence on the rate of change of acceleration; and if the spring state hold condition is determined to be satisfied, output a hold control signal to cause the air spring to remain operating in the high stiffness state.

The rate of change of acceleration may also be referred to as the gradient of the acceleration or may also be referred to as jerk.

Advantageously, by determining if the spring state hold condition is satisfied, in dependence upon the rate of change of acceleration, the spring state can be held during dynamic driving conditions. This may be, for example, when the rate of change of acceleration is high, for example during rapid oscillation between acceleration and braking of the vehicle, or when the vehicle swerves from side to side rapidly (also known as ‘slalom’). In this way, despite the acceleration of the vehicle reducing as the vehicle turns, the hold signal is sent and the air spring remains operating in the high stiffness state during these dynamic driving conditions.

The spring state hold condition may be satisfied when a magnitude of an adjusted acceleration is above a hold threshold. The adjusted acceleration may represent the acceleration of the vehicle, modified by one or more adjustment functions. The adjusted acceleration may be determined in dependence upon the rate of change of acceleration. The adjusted acceleration may be determined in dependence upon the acceleration.

Advantageously the hold control signal may be sent as a result of the adjusted acceleration, of the vehicle being above the respective threshold, whilst accounting for the aforementioned dynamic driving conditions by determining these adjusted acceleration values in dependence at least upon the rate of change of acceleration.

The magnitudes may also be referred to as absolute values, or the modulus or moduli of values.

The control system may be further configured to, when the air spring is operating in a high stiffness state during vehicle motion, receive a signal indicative of acceleration of the vehicle. The adjusted acceleration may be determined also in dependence upon the acceleration.

Advantageously, the adjusted acceleration may be determined in dependency upon both the acceleration and the rate of change of acceleration, to ensure that all dynamic driving conditions are accounted for. For example, during periods of consistently high acceleration, the rate of change of acceleration is low, and so it may be beneficial, when comparing the adjusted acceleration with the hold threshold, that the adjusted acceleration is high in representation of the acceleration.

The signal indicative of the rate of change of acceleration and the signal indicative of acceleration may be the same signal in some examples. The rate of change of acceleration may be determined as the gradient of an acceleration curve, for example.

A magnitude of the adjusted acceleration may decay at a slower rate, i.e. with a smaller gradient, than a corresponding magnitude of the acceleration. The magnitude of the adjusted acceleration may decay at a slower rate than a corresponding negative gradient portion of the magnitude of the acceleration. The adjusted acceleration may correspond to the acceleration via a decay function. The decay function may be dependent on the acceleration and/or the rate of change of acceleration of the vehicle. Advantageously, the decay in the magnitude of the adjusted acceleration may lag behind the decay of the magnitude of the acceleration, and so, where the acceleration value may fall below the hold threshold without a particular hold condition being used, the adjusted acceleration may stay above the hold threshold to maintain high spring stiffness. Advantageously, this means that the air spring remains in the high stiffness state during dynamic driving conditions.

The signal indicative of acceleration may comprise at least one signal part. A signal part may be indicative of one of: a lateral acceleration of the vehicle; and a longitudinal acceleration of the vehicle.

The control system may be configured to, if the spring state hold condition is determined to be satisfied with respect to any of the signal parts, output the hold control signal to cause the air spring to remain operating in the high stiffness state.

Advantageously, the hold control signal might be output if the adjusted acceleration of the vehicle in any direction is high.

The signal indicative of acceleration may be based upon an estimated acceleration of the vehicle. Advantageously, this may reduce the amount of data which must be processed, thereby reducing the computational power required in the control system. Further advantageously, this may reduce noise in the signal, as the signal is not based upon raw data.

The signal indicative of acceleration may be based upon an input relating to one or more of: a steering angle of the vehicle obtained from a user steering wheel input; and an acceleration of the vehicle obtained from one or more drive pedal inputs.

The magnitude of an adjusted acceleration determined in dependence upon the rate of change of acceleration (e.g. according to a rate-of-change-of-acceleration-dependent decay function) may decay at a slower rate than a corresponding magnitude of the adjusted acceleration determined in dependence upon the acceleration (e.g. according to an acceleration-dependent decay function). The magnitude of an adjusted acceleration adjusted according to a rate-of-change-of-acceleration-dependent decay function may decay at a slower rate in a corresponding negative gradient portion of the adjusted acceleration than a corresponding magnitude of the adjusted acceleration adjusted according to an acceleration-dependent decay function. Advantageously, the acceleration adjusted according to a rate-of-change-of-acceleration-dependent decay function lags behind the adjusted according to an acceleration-dependent decay function, and so, where the acceleration or acceleration adjusted according to the acceleration may pass below the hold threshold, the adjusted acceleration adjusted according to the rate of change of acceleration may stay above the hold threshold and maintain the air spring in the high stiffness state during dynamic driving conditions.

The signal indicative of the rate of change of acceleration may comprise at least one signal part. A signal part may be indicative of one of: a rate of change of lateral acceleration of the vehicle; and a rate of change of longitudinal acceleration of the vehicle.

The control system may be configured to, if the spring state hold condition is determined to be satisfied with respect to any the signal parts, output a hold control signal to cause the air spring to remain operating in the high stiffness state. Advantageously, the hold control signal may be output if the rate of change of acceleration of the vehicle in any direction is high.

The signal indicative of the rate of change of acceleration may be based upon an estimated rate of change of acceleration of the vehicle. Advantageously, this may reduce the amount of data which must be processed, thereby reducing the computational power require din the control system. Further advantageously, this may reduce noise in the signal, as the signal is not based upon raw data.

The signal indicative of the rate of change of acceleration may be based upon an input relating to one or more of: a steering angle of the vehicle obtained from a user steering wheel input; and an acceleration of the vehicle obtained from one or more drive pedal inputs.

According to an aspect of the invention there is provided a control system for an air spring of a suspension system of a vehicle, the control system comprising one or more controllers, the control system configured: when the air spring is operating in a high stiffness state during vehicle motion, receive a signal indicative of a rate of change of acceleration of the vehicle; determine if a spring stiffness reduction condition is satisfied in dependence on the rate of change of acceleration; and if the spring stiffness reduction condition is determined to be satisfied, output a switch control signal to cause the air spring to switch to operating in a low stiffness state.

The spring stiffness reduction condition may be satisfied when a magnitude of an adjusted acceleration is below a stiffness reduction threshold. The adjusted acceleration may represent the acceleration of the vehicle, modified by one or more adjustment functions. The adjusted acceleration may be determined in dependence upon the rate of change of acceleration. The adjusted acceleration may be determined in dependence upon the acceleration.

In either of the aforementioned control systems, the control system may be configured to: when the air spring is operating in a low stiffness state during vehicle motion, receive the signal indicative of the rate of change of acceleration of the vehicle; determine if a spring stiffness increasing condition is satisfied in dependence on the rate of change of acceleration; and if the spring stiffness increasing condition is determined to be satisfied, output a switch control signal to cause the air spring to switch to operating in a high stiffness state.

The spring stiffness increasing condition may be satisfied when a magnitude of an adjusted acceleration is above a spring stiffness increasing threshold. The adjusted acceleration may represent the acceleration of the vehicle, modified by one or more adjustment functions. The adjusted acceleration may be determined in dependence upon the rate of change of acceleration. The adjusted acceleration may be determined in dependence upon the acceleration.

The control system may be further configured to, when the air spring is operating in a low stiffness state during vehicle motion, receive the signal indicative of acceleration of the vehicle. The spring stiffness increasing condition may be satisfied when the magnitude of the acceleration is above the spring stiffness increasing threshold. The spring stiffness increasing condition may be satisfied when a magnitude of the rate of change of acceleration is above the spring stiffness increasing threshold.

The adjusted acceleration may be only determined when the acceleration is above the spring stiffness increasing threshold. The adjusted rate of change of acceleration may be only determined when the acceleration is above the spring stiffness increasing threshold. The adjusted rate of change of acceleration may be only determined when the rate of change of acceleration is above the spring stiffness increasing threshold. The adjusted acceleration may be only determined when the rate of change of acceleration is above the spring stiffness increasing threshold.

The signal indicative of acceleration may comprise at least one signal part, each of the at least one signal part being indicative of one of: a lateral acceleration of the vehicle; and a longitudinal acceleration of the vehicle.

The control system may be configured to, when the air spring is operating in the low stiffness state and if the spring stiffness increasing condition is determined to be satisfied with respect to any of the signal parts, output a switch control signal to cause the air spring to switch to operating in the high stiffness state.

The control system may be configured to, when the air spring is operating in the high stiffness state and if the spring stiffness reduction condition is determined to be satisfied with respect to all of the signal parts, output a switch control signal to cause the air spring to switch to operating in the low stiffness state.

The signal indicative of acceleration may comprise at least one signal part, each of the at least one signal part being indicative of one of: a lateral rate of change of acceleration of the vehicle; and a longitudinal rate of change of acceleration of the vehicle.

The control system may be configured to, when the air spring is operating in the low stiffness state and if the spring stiffness increasing condition is determined to be satisfied with respect to any of the signal parts, output a switch control signal to cause the air spring to switch to operating in the high stiffness state.

The control system may be configured to, when the air spring is operating in the high stiffness state and if the spring stiffness reduction condition is determined to be satisfied with respect to all of the signal parts, output a switch control signal to cause the air spring to switch to operating in the low stiffness state

One or more of the hold threshold, spring stiffness reduction threshold, and spring stiffness increasing threshold may be the same.

The control system may be configured to receive an input from a mode selector. The mode selector may be controlled by a user, for example by the driver of the vehicle. The mode selector may be used to alter a relationship between the adjusted acceleration and the acceleration or the adjusted rate of change of acceleration and the rate of change of acceleration. For example, the mode selector may be used to alert the decay function between the adjusted acceleration and the acceleration or the adjusted rate of change of acceleration and the rate of change of acceleration.

One or more of the hold threshold, spring stiffness reduction threshold, and spring stiffness increasing threshold may be set based upon driving conditions and/or based upon the input from the mode selector.

The spring stiffness increasing threshold may be lower than the hold threshold, and/or may be lower than the spring stiffness reduction threshold.

The adjusted acceleration and the corresponding acceleration may be substantially the same during an increase of, and during a constant magnitude of, the acceleration.

The adjusted rate of change of acceleration and the corresponding rate of change of acceleration may be substantially the same during an increase of, and during a constant magnitude of, the rate of change of acceleration.

Causing the air spring to switch from operating in the high stiffness state to operating in the low stiffness state may comprise closing a valve in the air spring to decrease the volume of an air chamber in the air spring.

Causing the air spring to switch from operating in a low stiffness state to operating in the high stiffness state may comprise opening a valve in the air spring to increase the volume of an air chamber in the air spring.

According to an aspect of the invention there is provided a system comprising any air spring as disclosed herein, and any control system disclosed herein.

According to an aspect of the invention there is provided a vehicle comprising any control system, or system, disclosed herein.

According to an aspect of the invention there is provided a method of operating a control system for an air spring of a vehicle, the method comprising: when the air spring is operating in a high stiffness state during vehicle motion, receiving a signal indicative of a rate of change of acceleration of the vehicle; determining if a spring state hold condition is satisfied in dependence on the rate of change of acceleration; and if the spring state hold condition is determined to be satisfied, outputting a hold control signal to cause the air spring to remain operating in the high stiffness state.

According to an aspect of the invention there is provided a method of operating a control system for an air spring of a vehicle, the method comprising: when the air spring is operating in a high stiffness state during vehicle motion, receiving a signal indicative of a rate of change of acceleration of the vehicle; determining if a spring stiffness reduction condition is satisfied in dependence on the rate of change of acceleration; and if the spring stiffness reduction condition is determined to be satisfied, outputting a switch control signal to cause the air spring to switch to operating in a low stiffness state.

According to an aspect of the invention there is provided computer software which, when executed on a processor of any control system disclosed herein, is arranged to perform any method disclosed herein.

According to an aspect of the invention there is provided a non-transitory, computer-readable storage medium storing instructions thereon that, when executed by one or more electronic processors of any control system disclosed herein, causes the one or more electronic processors to carry out any method disclosed herein.

### BRIEF DESCRIPTION OF THE DRAWINGS

One or more examples will now be described, by way of example only, with reference to the accompanying drawings, in which:

FIG. 1 shows a control system for a damper according to examples disclosed herein;

FIG. 2a shows, schematically, a high level overview of a variable stiffness spring, according to examples disclosed herein;

FIG. 2b shows, schematically, a high level overview of an example suspension system comprising a variable stiffness spring system, according to examples disclosed herein;

FIG. 3a shows how switching between low and high spring stiffness may be performed according to acceleration;

FIG. 3b shows an example of how switching between low and high spring stiffness may be performed accounting for rate of change of acceleration according to examples disclosed herein;

FIGS. 4a-4c show an example of using decay functions to obtain a modified acceleration, which may be used to determine switching spring stiffness, according to examples disclosed herein;

FIG. 5 shows an example of a logic flow to determine whether to maintain a high spring stiffness state in dependence on the rate of change of acceleration, according to examples disclosed herein;

FIG. 6 illustrates an example method according to examples disclosed herein and

FIG. 7 illustrates an example vehicle according to examples disclosed herein.

### DETAILED DESCRIPTION

Vehicles typically comprise active suspension systems for maintaining vehicle stability. Some active suspension systems have variable stiffness springs, such as adaptive air springs, also known as additional switchable volume (ASV) air springs. ASV air springs with two air chambers may be switchable between a low stiffness state and a high stiffness state. In the low stiffness state, a volume of air inside of a chamber of the air spring is relatively large, such that the volume of air has a lower stiffness to resist movement of a piston acting inside of the chamber. In the high stiffness state, the volume of air inside the air spring is relatively small, such that the volume of air has a lower stiffness to resist movement of a piston acting inside of the chamber. In an example of an air spring with two air chambers, a valve may be located between the chambers. The valve may be opened or closed, to form the large chamber or a smaller chamber, so the air spring can operate in the low stiffness state or the high stiffness state, respectively.

The air spring may be controlled by a control system which sends switching signals to the valve of the air spring. The switching command may be sent based upon a selected driving mode, such as winter driving or sports driving mode. Such a mode may be selected by the driver of the vehicle.

In some cases, the air spring may be switched between states based upon measured acceleration values. In such cases, when the measured acceleration increases to above a threshold, the air spring is switched to operate in the high stiffness state. When the measured acceleration reduces to below a threshold, the air spring is switched to the low stiffness state. If the acceleration of the vehicle is discontinuous or changes between values crossing the switching threshold(s), the air springs may switch between high and low stiffness states repeatedly, which may lead to an uncomfortable driving experience. Furthermore, during dynamic driving conditions, such repeated switching may often take place, which is undesirable.

Notwithstanding these disadvantages, operating a valve control system in this way may be computationally expensive, as acceleration is measured using a sensor such as an accelerometer, and so the control system must process a large quantity of data being received from the sensor. Also, anomalous data points may cause false indications that a threshold has been passed, and so the air springs may be controlled to switch stiffness state at an inopportune moment. Furthermore, disclosures herein relating to air springs are applicable more broadly to any type of variable stiffness spring, in which plural different spring settings can be controlled by a control system and implemented by the variable stiffness spring.

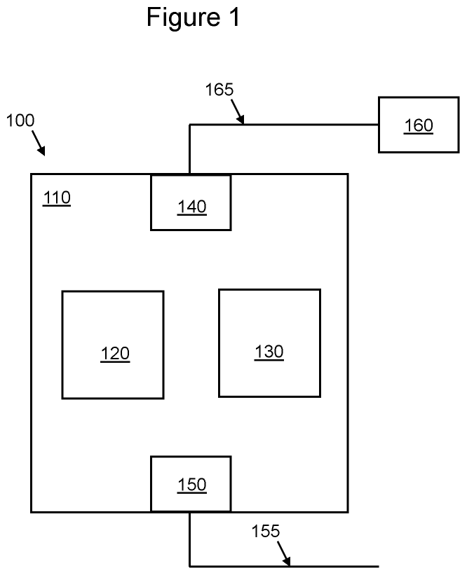

FIG. 1 shows a control system 100 for an air spring of a suspension system of a vehicle. The vehicle may be a wheeled vehicle, such as an automobile, or may be another type of vehicle. The air spring(s) are variable stiffness air spring(s) system which can be controlled to provide different spring stiffnesses. The vehicle suspension system may comprise an active roll control system in some examples.

The control system 100 comprises one controller 110, although in other examples there may be plural controllers 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 165 of the controller 110. The output means 150 may comprise an electrical output 155 of the controller 110. The input 140 is arranged to receive one or more input signals via the electrical input 165, for example from an external computing device or a sensor, e.g. an accelerometer 160.

In one example, the control system 100 may operate based on the operation of the air spring being in a high stiffness state and consider a condition to cause the high stiffness state to be maintained. In such an example, when the air spring is operating in a high stiffness state during vehicle motion, the control system 100 is configured to receive a signal as input 165 which is indicative of a rate of change of acceleration of the vehicle. The rate of change of acceleration may also be referred to as the gradient of the acceleration or may also be referred to as jerk. The control system 100 is configured to then determine if a spring state hold condition is satisfied in dependence on the rate of change of acceleration. As discussed in more detail below, there are different ways in which the rate of change of acceleration of the vehicle may be accounted for in determining of the spring state hold condition is satisfied.

The control system 100 is configured to then, if the spring state hold condition is determined to be satisfied, output a hold control signal 155 to cause the air spring to remain operating in the high stiffness state. In this way, there is a determination made that maintaining a high spring stiffness state should be performed in dependence on a condition being met, which is dependent on the rate of change of acceleration of the vehicle. The control system 100 may therefore control the properties of the air spring(s) by way of determining a rate of change of acceleration behaviour and determining if that indicates that maintaining a high spring stiffness may be beneficial.

Advantageously, by determining if the spring state hold condition is satisfied, in dependence upon the rate of change of acceleration, the spring state can be held during dynamic driving conditions. This may be, for example, when the rate of change of acceleration is high, for example during rapid oscillation between acceleration and braking of the vehicle, or when the vehicle swerves from side to side rapidly (also known as ‘slalom’). In this way, despite the acceleration of the vehicle reducing as the vehicle turns, the hold signal is sent and the air spring remains operating in the high stiffness state during these dynamic driving conditions.

The control system 100 may thus control maintaining the high stiffness state as above. The control system 100 may, additionally, or instead, consider an air spring in a high stiffness state and determine whether a condition is met for moving the springs into a low stiffness state. In such an example the control system 100 may be configured to, as before, when the air spring is operating in a high stiffness state during vehicle motion, receive a signal 165 indicative of a rate of change of acceleration of the vehicle. The control system 100 may then determine if a spring stiffness reduction condition is satisfied in dependence on the rate of change of acceleration. If the spring stiffness reduction condition is determined to be satisfied, the control system 100 may output a switch control signal 155 to cause the air spring to switch to operating in a low stiffness state.

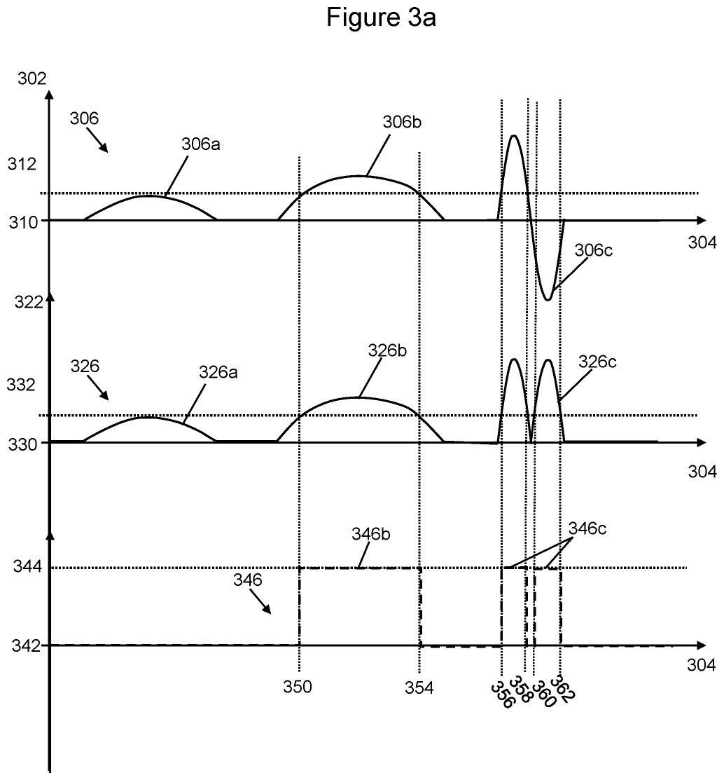

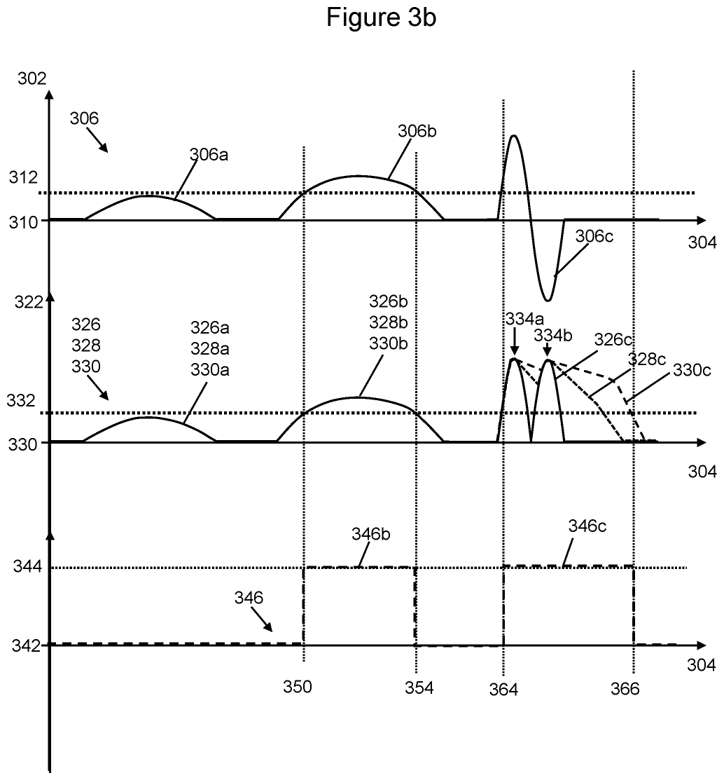

The spring state hold condition may be satisfied when a magnitude of an adjusted acceleration is above a hold threshold, wherein the adjusted acceleration is determined in dependence upon the rate of change of acceleration. On meeting the spring state hold condition the springs may be controlled to remain in a high spring stiffness state. The acceleration of the vehicle may be received and adjusted according to a function which is dependent on the rate of change of acceleration of the vehicle. The acceleration of the vehicle may also be adjusted according to a function which is dependent on the acceleration of the vehicle as well in some examples. Examples of ways of determining an adjusted acceleration is discussed below in relation to FIG. 3b and FIGS. 4a-4c. In some examples, the spring stiffness reduction condition may be satisfied when a magnitude of an adjusted acceleration is below a spring stiffness reduction threshold in some examples, wherein the adjusted acceleration is determined in dependence upon the rate of change of acceleration. On meeting the spring stiffness reduction condition the springs may be controlled to change from a high to a low spring stiffness.

Furthermore, any of the abovementioned control systems 100 may also be configured to control the air spring 250 when operating in a low stiffness state. For example, the control system 100 may be configured to, when the air spring is operating in a low stiffness state during vehicle motion, receive a signal 165 indicative of the rate of change of acceleration of the vehicle. The control system 100 may determine if a spring stiffness increasing condition is satisfied in dependence on the rate of change of acceleration. If the spring stiffness increasing condition is determined to be satisfied, the control system 100 may output a switch control signal 155 to cause the air spring to switch to operating from a low to a high stiffness state.

The spring stiffness increasing condition may be satisfied when a magnitude of an adjusted acceleration is above a stiffness increasing threshold in some examples. The adjusted acceleration may be determined in dependence upon the rate of change of acceleration. On meeting the spring stiffness increasing condition, the springs may be controlled to change from a low to a high spring stiffness.

Thus generally, the spring stiffness of a variable stiffness spring may be controlled in dependence on the rate of change of acceleration of the vehicle.

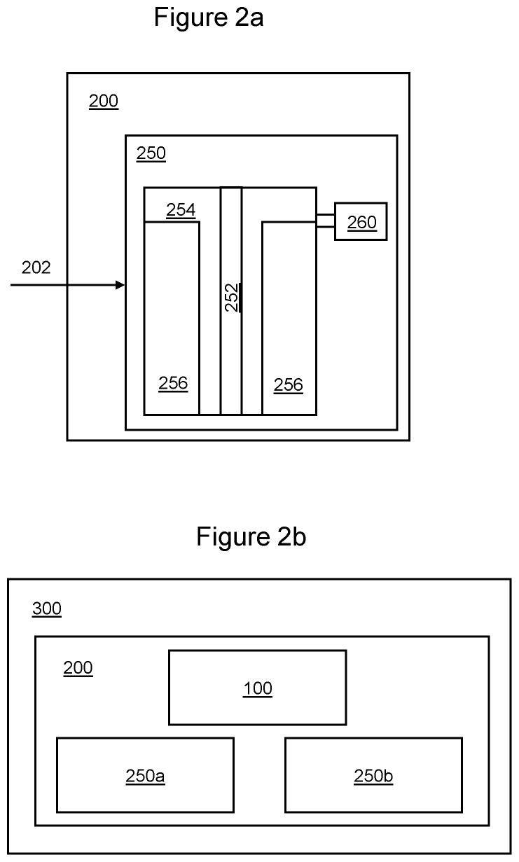

FIG. 2a shows, schematically, a high level overview of a variable stiffness spring system 200 comprising a dynamic air spring 250, according to examples disclosed herein. A dynamic air spring 250 may also be called an adaptive air spring, multi-chamber air spring, variable stiffness spring, or an additional switchable volume (ASV) air spring. Such air springs 250 comprise a set of physical volumes which are connected via adjustable restrictions. In this example one multi-chamber air spring 250 is illustrated but the variable stiffness spring system 200 may comprise plural multi-chamber air springs 250, e.g. one per wheel. FIG. 2a is schematic: the relative volume sizes of the different air chambers 254, 256 is not to scale, and may not be representative of actual volume sizes or volume ratios between different air chambers in real air springs.

The air spring 250 comprising a damper 252, a first air chamber 254 and a second air chamber 256, and a valve 260. The damper 252 sits in the centre of the assembly 250, and the air spring comprising the chambers 254, 256 encapsulates it. When the valve 260 is closed, the first and second air chambers 254, 256 are separated from each other. When the valve 260 is open, the first and second air chambers 254, 256 are connected and an air spring force is achieved due to air in the first and second chambers 254, 256 together. By switching the air chamber volume available, in response to a control signal 202 from a control system 100 controlling the air spring 250, the air spring stiffness is changed to provide different possible air spring force effects. The larger the available air volume (e.g. when the first air chamber 254 and the second air chamber 256 are connected by an open valve 260), the lower the air spring is. The smaller the air volume (e.g. when the first air chamber 254 is separated from the second air chamber 256 by the valve 260 so first air chamber 254 is available to provide an air spring force, but the second air chamber 256 is not available), the stiffer the air spring 250 is. Closing the valve 260 in the air spring to decrease the volume of an air chamber in the air spring causes the air spring 250 to switch from operating in the high stiffness state to operating in the low stiffness. Opening a valve in the air spring to increase the volume of an air chamber in the air spring causing the air spring to switch from operating in a low stiffness state to operating in the high stiffness state.

The example air spring 250 shown comprises two volumes 254, 256 connected via one valve 260, such as an electronically adjustable valve. This allows for separate spring rates (stiffnesses) to be effected by having the valve 260 closed or open. Another example air spring may comprise three volumes, connected via two valves such as electronically adjustable valves. This allows for more possible separate spring rates (stiffnesses) by having the valves closed or open in different combinations.

FIG. 2b shows schematically a vehicle suspension system 300 according to examples disclosed herein. The vehicle suspension system 300 comprises a variable stiffness spring system 200. The vehicle suspension system 300 may comprise other elements, such as passive springs or dampers, or one or more sensors, for example. The active suspension system 200 comprises a control system 100 such as that described in relation to FIG. 1, and in this example, a plurality of variable stiffness springs 250a, 250b as shown in FIG. 2a. In other examples there may be one, or more than two, such variable stiffness springs 250a, 250b. The active suspension system 200 may comprise other elements, such as electronic dampers, for example.

FIG. 3a shows a graph 306 indicating schematically an example variation in acceleration 302 of a vehicle against time 304, and a graph 326 indicating a corresponding example variation in the magnitude of the acceleration 322 of the vehicle against time 304. The magnitudes may also be referred to as absolute values or the modulus or moduli of values. Also shown is an example graph 346 of switching the operation of an air spring between high stiffness 344 and low stiffness 342 according to the acceleration 302.

The graph of acceleration 302 against time 304 shows a variation which switches between positive and negative acceleration values. In a first acceleration portion 306a, the acceleration rises from zero and falls back to zero, with a maximum acceleration value below an acceleration threshold 312. In a second acceleration portion 306b, the acceleration rises from zero and falls back to zero, with a maximum acceleration value above the acceleration threshold 312. In a third acceleration portion 306c, the acceleration rises from zero and falls back to zero, then falls to a negative value before rising again to zero, with a maximum acceleration value above the acceleration threshold 312.

The graph of the magnitude of the acceleration 322 against time 304 shows that, for the first and second acceleration portions 306a, 306b, since these are already accelerations with positive values, there is no change between the acceleration 306a, 306b, and the magnitude of the acceleration 326a, 326b. For the third acceleration portion 306c, where the acceleration values are negative, the curve is reflected in the time axis (x axis) to provide the magnitude of the acceleration values 326c, which is always a positive value. Therefore the curve indicating the magnitude of the acceleration 326 varies between zero and a positive value. Also indicated on the graph 326 of the magnitude of the acceleration 322 against time 304 is a threshold 332. The curve indicating the magnitude of the acceleration 326 in this example crosses the threshold 332 in the second acceleration portion 326b at times 350, 354, and in the third acceleration portion 326c at several time values 356, 358, 360, 362.

The graph 346 of switching the operation of an air spring between high stiffness 344 and low stiffness 342 according to the acceleration 302, 342 shows that, in relation to the first acceleration portion 306a, 326a, since the acceleration values 326a do not exceed (or reach) the threshold acceleration value 332, the spring stiffness is not changed and remains at a low stiffness value 342. In relation to the second acceleration portion 306b, 326b, since the acceleration values 326b exceed the threshold acceleration value 332, the spring stiffness is changed while the acceleration values are above the threshold 332. That is, at the time 350 of the acceleration value exceeding the threshold 332, the spring stiffness switches from a low stiffness 342 to a high stiffness 344, and at the time 354 of the acceleration value falling back below the threshold 332, the spring stiffness switches from the high stiffness 344 to the low stiffness 342, as shown in spring stiffness graph portion 346b.

In relation to the third acceleration portion 306c, since the magnitude of the acceleration values 326c exceed the threshold acceleration value 332 at two instances, the spring stiffness is changed to high stiffness while the acceleration values are above the threshold 332 in those instances. Because the magnitude of the acceleration 326 is considered, and the acceleration in the third period 306c includes a positive peak followed by a negative trough, the magnitude of the acceleration 326c shows two peaks. So, at the time 356 of the magnitude of the acceleration value 326c exceeding the threshold 332, the spring stiffness switches from a low stiffness 342 to a high stiffness 344; at the time 358 of the magnitude of the acceleration value 326c falling back below the threshold 332, the spring stiffness switches from the high stiffness 344 to the low stiffness 342, as shown in spring stiffness graph portion 346b. This repeats for the second peak in the acceleration magnitude 326c, i.e. at the time 360 of the magnitude of the acceleration value 326c exceeding the threshold 332, the spring stiffness switches from a low stiffness 342 to a high stiffness 344, and at the time 362 of the magnitude of the acceleration 326c value falling back below the threshold 332, the spring stiffness switches from the high stiffness 344 to the low stiffness 342, as shown in spring stiffness graph portion 346c.

The acceleration shown in the third portion 306c may be considered to represent a dynamic manoeuvre of the vehicle. During dynamic driving, it may be desirable to maintain a high spring stiffness to support handling of the vehicle in a responsive way. Switching the spring stiffness as shown in FIG. 3a for this manoeuvre incurs two changes to high spring stiffness from low spring stiffness, and back again, but it may be an improvement to switch to high spring stiffness at the start of the manoeuvre 356 and switch back to low spring stiffness at the end of the manoeuvre 362 without switching during the overall manoeuvre. Examples disclosed herein allow for such switching to be performed, by in effect indicating that the high spring stiffness state should be held until the dynamic manoeuvring has completed.

FIG. 3b shows a graph 306 indicating schematically an example variation in acceleration 302 of a vehicle against time 304, and a graph 326 indicating a corresponding example variation in the magnitude of the acceleration 322 of a vehicle against time 304, as in FIG. 3a. Also shown is an example graph 346 of switching the operation of an air spring between high stiffness 344 and low stiffness 342 according to the acceleration 302 and according to examples of the present disclosure, by applying a “hold” to the high spring stiffness during a dynamic manoeuvre (represented by the third illustrated acceleration profile 306c).

The graph 306 of acceleration 302 against time 304 shows a variation which switches between positive and negative values in the same way as in FIG. 3a, and the graph 326 of the magnitude of the acceleration 322 against time 304 shows the same magnitude of the acceleration as in FIG. 3a, again with the same threshold 332 shown as in FIG. 3a.

In addition to the graph 326 of the magnitude of the acceleration in FIG. 3a, two modified acceleration curves 328, 330 are also shown. These are easily seen in relation to the third acceleration portion 326c as modified acceleration curve portions 328c, 330c. They are also calculated and shown across the full time range, as first modified acceleration curve portions 328a, 330a and 328b, 330b, but these portions are colinear with the first and second acceleration portions 326a, 326b and so the curves overlie each other in the first and second portions.

The modified acceleration curves 328, 330 are calculated using the magnitude of the acceleration curve 326 and respective decay functions, which are discussed in more detail in relation to FIGS. 4a-4c. A first modified acceleration curve 328 is obtained by applying a variable decay, as a function of the acceleration, to the input magnitude of the acceleration 326. Curve 330 shows a second modified acceleration curve obtained by applying a variable decay, as a function of the rate of change of acceleration (i.e. the gradient, or the derivative, of the magnitude of the acceleration curve 326), to the input magnitude of the acceleration 326.

It can be seen that the first modified acceleration curve 328 follows the unmodified magnitude of the acceleration curve 326 in the first acceleration portion and the second acceleration portion. In these portions, the values of the magnitude of the acceleration 326 are low enough that the decay function, which is dependent on the acceleration, applied to obtain the first modified acceleration curve 328 and the second modified acceleration curve 330, has negligible effect. Similarly, the second modified acceleration curve 330 follows the unmodified magnitude of the acceleration curve 326 in the first acceleration portion and the second acceleration portion. In these portions, the values of the acceleration and of the rate of change of acceleration are low enough that the decay function, which is dependent on the rate of change of the acceleration, i.e. on the gradient of the curve 326, and which is applied to obtain the first modified acceleration curve 328 and the second modified acceleration curve 330, has negligible effect.

In the third acceleration portion, the magnitude of the acceleration 326c and the rate of change of the magnitude of the acceleration 326c are high enough that the respective decay functions applied to the magnitude of the acceleration 326c in this portion generate a first and second modified acceleration curve 328c, 330c which deviates from the unmodified curve of the magnitude of the acceleration 326c. The first modified acceleration curve 328c decreases after the peak acceleration 334a, 334b at a slower rate (shallower gradient) than the unmodified acceleration curve 326, so it takes a longer time for the curve 328c to reach the threshold acceleration value 332 to cause spring stiffness switching from high stiffness 344 to low stiffness 342. The second modified acceleration curve 330c decreases after the peak acceleration 334a, 334b at a slower rate (shallower gradient) than the unmodified acceleration curve 326c and at a slower rate than the first modified acceleration curve 328c, so it takes an even longer time for the curve 330c to reach the threshold acceleration value 332 to cause spring stiffness switching from high stiffness 344 to low stiffness 342.

In other words, the magnitude of the adjusted acceleration 328, 330 may decay at a slower rate than a corresponding magnitude of the acceleration 326. The magnitude of the adjusted acceleration 328, 330 may decay at a slower rate than a corresponding negative gradient portion of the magnitude of the acceleration 326. The adjusted acceleration 328, 330 may correspond to the acceleration 326 via a decay function as described in relation to FIGS. 4a-4c. Advantageously, the decay in the magnitude of the adjusted acceleration 328, 330 may lag behind the decay of the magnitude of the acceleration 326, and so, where the acceleration may pass to below the hold threshold 332 without a particular hold conditions (i.e. adjusted accelerations) being used, the adjusted acceleration 328, 330 may stay above the hold threshold 332 to maintain high spring stiffness 344. Advantageously, this means that the air spring remains in the high stiffness state during dynamic driving conditions.

The graph 346 of switching the operation of an air spring between high stiffness 344 and low stiffness 342 according to the second modified acceleration curve 330 (which would be similar to the behaviour obtained if considering the first modified acceleration curve 328) shows that, in relation to the first acceleration portion 306a, 326a, and second acceleration portion 306b, 326b, the switching takes place in the same way as without any decay functions being applied so that the spring stiffness 346 is switched in the second portion to a high spring stiffness at a first time 350 when the second modified acceleration 330 (which is substantially the same as the acceleration 326 in this portion) exceeds the threshold 322 and switches back to a low spring stiffness at a later time 354 when the second modified acceleration 330 (which is substantially the same as the acceleration 326 in this portion) falls below the threshold 322. This is because during the first acceleration portion 306a, 326a, the modified acceleration 328a, 330a values (colinear with the magnitude of the acceleration here 326a) do not reach the threshold 312, 332 to cause the spring stiffness to switch to the high stiffness state. During the second acceleration portion 306b, 326b, the modified acceleration values 328b, 330b (which again are colinear with the magnitude of the acceleration here 326b) reach the threshold 332 to cause the spring stiffness 346 to switch to the high stiffness state 344, and then falls below the threshold 312, 332 to cause the spring stiffness to switch back to the low stiffness state 342, in the same way as the unadjusted acceleration 326.

In relation to the third acceleration portion 306b, 326c, the magnitude of the first modified acceleration curve 328c exceeds the threshold acceleration value 332 at a first instance, at which the spring stiffness is changed to high stiffness 344 while the magnitude of the acceleration values are above the threshold 332. Also, the magnitude of the second modified acceleration curve 330c exceeds the threshold acceleration value 332 at a first instance 364, at which the spring stiffness is changed to a high stiffness 344 while the magnitude of the acceleration values are above the threshold 332. However, even though the magnitude of the acceleration curve 326c dips below the threshold value 332, the first modified acceleration curve 328c does not fall below the threshold value 332 until after the second magnitude of the acceleration peak 334b has fallen below the threshold value 332. Similarly, the second modified acceleration curve 330c does not fall below the threshold value 332 until after the second magnitude of the acceleration peak 334b has fallen below the threshold value 332, as shown at a time 366.

The spring stiffness switching behaviour 346 shown at the end of the third portion relates to the second modified acceleration 330 in this figure, in which the function applied to the magnitude of the acceleration 326 to obtain the second modified acceleration 330 is a function of the rate of change of acceleration. Similarly, the spring stiffness switching behaviour 346 may be performed according to the magnitude of the acceleration modified according to a modifying function which is a function of the acceleration in other examples. In some examples, the spring stiffness switching behaviour 346 may be performed according to the magnitude of the acceleration modified according to a modifying function which is either a) a function of the acceleration or b) a function of the rate of change of the acceleration in other examples, wherein there is a condition to determine which of the modifying functions is applied. For example, such a condition may be that the modifying function applied to the magnitude of the acceleration is that which provides the slowest reduction in value, and therefore holds the high spring stiffness state for longest. In the third portion, the spring stiffness 346 is switched to a high spring stiffness at a first time 364 when the second modified acceleration 330 exceeds the threshold 322, and switches back to a low spring stiffness at a later time 366 when the second modified acceleration 330 falls below the threshold 322. The first and second modified acceleration curves 328, 330 may be considered to be damped versions of the unmodified acceleration 326 to allow the spring stiffness switching to be held at “high” stiffness.

The control system of FIG. 1 may be configured to operate as illustrated in FIG. 3b in some examples. From the point of view of a variable stiffness air spring of the vehicle operating at the high stiffness state during vehicle motion, as shown in FIG. 3b in relation to the third acceleration portion 346c, the control system may be configured to receive a signal indicative of a rate of change of acceleration of the vehicle. This may be, for example, from a sensor of a rate of change of acceleration sensor, or may be from an acceleration sensor whereby the sensed acceleration is differentiated to obtain the gradient, and therefore an indication of the rate of change of acceleration.

The control system may then determine if a spring state hold condition is satisfied in dependence on the rate of change of acceleration. The hold condition may be thought of in some examples as an indication that the spring state should stay at high stiffness, even if the value of the acceleration itself may be low (such as between the two peaks in acceleration magnitude 326c in FIG. 3b). The indication may be that the vehicle is performing a dynamic manoeuvre or other driving behaviour during which a high spring stiffness may be preferential to a low spring stiffness. The indication is shown in FIG. 3b as a modified acceleration value obtained from the modified acceleration curve 328c, 330c.

If the spring state hold condition is determined to be satisfied (for example, the modified acceleration value is above the threshold value 332), the control system may be configured to output a hold control signal to cause the air spring to remain operating in the high stiffness state. The spring stiffness state may otherwise be a low stiffness state such as between the two acceleration peaks in the third portion of FIG. 3b, but the hold control signal causes the spring stiffness to stay high.

The examples shown in FIG. 3b show, for example, the variation in the lateral acceleration a_{y} of the vehicle (that is, perpendicular to the direction of travel of the vehicle) as a function of time 302. In this example, the spring state hold condition of FIG. 3b is satisfied when a magnitude of an adjusted lateral acceleration 328c, 330c, which is determined in dependence upon the rate of change of lateral acceleration, is above a first (lateral acceleration) hold threshold 332.

Similar examples may also be illustrated in relation to:
the variation in longitudinal acceleration aₓ (that is, parallel to the direction of travel of the vehicle and perpendicular to the lateral acceleration a_{y}) as a function of time 302, whereby the hold condition may be satisfied if the adjusted longitudinal acceleration, determined in dependence upon the rate of change of acceleration, is above a longitudinal acceleration hold threshold. The adjusted longitudinal acceleration is based on the magnitude of the longitudinal acceleration aₓ, similarly to the adjusted lateral acceleration being based on the magnitude of the lateral acceleration a_{y};
the rate of change of lateral acceleration da_{y}/dt of the vehicle as a function of time 302, whereby the hold condition may be satisfied if the adjusted rate of change of lateral acceleration, determined in dependence upon the rate of change of acceleration, is above a lateral rate of change of acceleration hold threshold; and
the rate of change of longitudinal acceleration daₓ/dt of the vehicle as a function of time 302, whereby the hold condition may be satisfied if the adjusted rate of change of longitudinal acceleration, determined in dependence upon the rate of change of acceleration, is above a longitudinal rate of change of acceleration hold threshold.

Thus the signal indicative of acceleration which is provided to the control system 100 may comprise at least one signal part which is indicative the lateral acceleration of the vehicle or the longitudinal acceleration of the vehicle. The control system 100 may be configured to, if the spring state hold condition is determined to be satisfied with respect to any of the signal parts (lateral or longitudinal), output the hold control signal to cause the air spring to remain operating in the high stiffness state. Advantageously, the hold control signal may be output if the acceleration of the vehicle in any direction is high.

The modified acceleration or modified rate of change of acceleration (lateral or longitudinal) is determined in these examples based on the rate of change of acceleration. The modified acceleration or modified rate of change of acceleration (lateral or longitudinal) may also be determined based on the acceleration in some examples. The signal indicative of the rate of change of acceleration and the signal indicative of acceleration may be the same signal in some examples. Thus the control system may be configured to, when the air spring is operating in a high stiffness state during vehicle motion, receive a signal indicative of acceleration of the vehicle, and determine an adjusted acceleration in dependence upon the acceleration. The modified acceleration or modified rate of change of acceleration (lateral or longitudinal) may be determined based on the acceleration without consideration of the rate of change of acceleration in some examples.

Advantageously, in examples using an adjusted acceleration determined based on both the acceleration and the rate of change of acceleration, dynamic driving conditions may be comprehensively accounted for. For example, during periods of consistently high acceleration, the rate of change of acceleration is low, so it may be beneficial to account for both the acceleration and the rate of change of acceleration in determining whether to maintain a high spring stiffness, e.g. by obtaining the adjusted acceleration. In some examples, advantageously, a hold control signal to maintain high spring stiffness may be sent as a result of either the acceleration or the rate of change of acceleration of the vehicle causing a modified acceleration to be above the respective threshold. FIGS. 4a-4c sets out in more detail an example of a logic arrangement to determine an adjusted acceleration dependent on the acceleration and/or rate of change of acceleration.

The signal indicative of acceleration may be based upon an estimated acceleration of the vehicle. Advantageously, this may reduce the amount of data which must be processed, thereby reducing the computational power require din the control system. Further advantageously, this may reduce noise in the signal, as the signal is not based upon raw data but on an estimation which may be obtained to include no or little noise.

The signal indicative of acceleration in some examples may be based upon an input relating to a steering angle of the vehicle obtained from a user steering wheel input; and/or an acceleration of the vehicle obtained from one or more drive pedal inputs, for example. Therefore, examples disclosed herein aim to provide control of the air spring stiffness switching in situations of dynamic driving when the acceleration may vary but maintaining a high spring stiffness is desirable.

FIGS. 4a-4c show an example of using decay functions 406, 408 to obtain a modified lateral acceleration 462 a_{y}, which may be used to determine switching spring stiffness. While a modified lateral acceleration 462 a_{y} is discussed in the illustrated example, similar examples which may be used include obtaining a modified longitudinal acceleration aₓ, a modified rate of change of lateral acceleration da_{y}/dt and/or a modified rate of change of longitudinal acceleration daₓ/dt.

FIG. 4a shows that the lateral acceleration 452 is provided as input to a “delay” or “hold” module 404. The delay/hold applied to the lateral acceleration 452 in this example is dependent on both the lateral acceleration 452, via the decay function 406 of FIG. 4b, and on the rate of change of lateral acceleration 454, via the decay function 408 of FIG. 4c. In some examples, the delay/hold applied to the lateral acceleration 452 may be dependent on the rate of change of lateral acceleration 454 without considering the acceleration per se in modifying the acceleration to obtain an adjusted, or “held”, acceleration.

The lateral acceleration 452 is also provided as input to a lateral acceleration decay function 406 shown in FIG. 4b. The lateral acceleration decay function 406 applies a decay rate 424 in ms⁻²/s to the lateral acceleration 422 to obtain a modified lateral acceleration 456. This lateral decay function 406 shows that as the lateral acceleration value 422 increases, the slower the decay rate 424 is which is applied to the input lateral acceleration 452.

The rate of change of lateral acceleration 454 is provided as input to a rate of change of lateral acceleration decay function 408 shown in FIG. 4c. The rate of change of lateral acceleration decay function 408 applies a decay rate 434 in ms⁻³/s to the rate of change of lateral acceleration 432 to obtain a modified rate of change of lateral acceleration 458. This lateral decay function 408 shows that as the rate of change of lateral acceleration value 432 increases, the slower the decay rate 434 is which is applied to the input lateral acceleration 452.

The modified lateral acceleration 456 and the modified rate of change of lateral acceleration 458 in this example are provided as input to a minimum module 410 which determines which parameter of the acceleration or the rate of change of acceleration has the minimum decay rate, and the minimum decay rate is used as the decay, or “hold”, to be applied to the lateral acceleration 452 and provide the modified lateral acceleration 462. The minimum decay rate provides the longest hold time. This may be, for example, the modified acceleration curve 328 (modified according to the decay-rate applied to the lateral acceleration 456 modified acceleration curve 328 if this is the minimum decay rate) or modified acceleration curve 330 (modified according to the decay-rate applied to the rate of change of lateral acceleration 458 to obtain the modified acceleration curve 330 if this is the minimum decay rate) in FIG. 3b.

In other words, the process in FIG. 4a provides hold functionality to maintain a high spring stiffness state. Inputs of lateral acceleration 452 and rate of change of acceleration 454 are fed into two respective decay maps 406, 408 to determine a decay to be applied to the lateral acceleration 452. The minimum decay rate, determined by the minimum module 410, as a function of lateral acceleration 452 and rate of change of lateral acceleration 454 is determined, in order to “hold” the spring state for the longest possible time. The decay is then applied to the input lateral acceleration to obtain the “held acceleration” 328, 330.

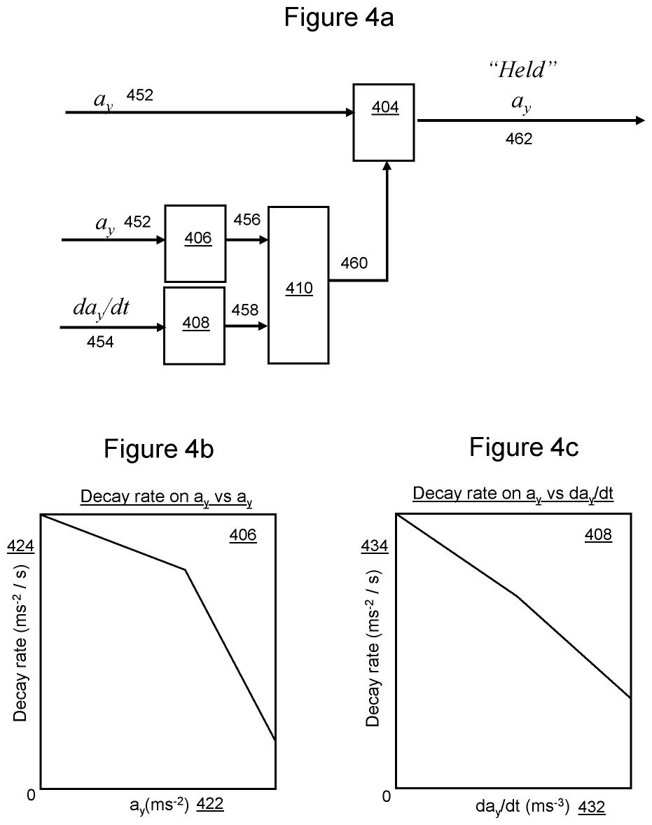

FIG. 5 illustrates an example logic architecture 500 which may be used to determine the spring stiffness state. In this example, the “hold logic” which is used to determine whether to maintain a high spring stiffness state for each wheel accounts for five functions (this may be, for example, four respective versions of the logic of FIG. 4a for each of the four parameters and a mode logic 530). The four parameter functions in this example are the spring state request 502 (e.g. the switching curve 346 of FIG. 3b) determined according to the lateral acceleration a_{y}, the spring state request 506 determined according to longitudinal acceleration aₓ, the spring state request 504 determined according to rate of change of lateral acceleration da_{y}/dt and the spring state request 508 determined according to rate of change of longitudinal acceleration daₓ/dt. In other words, spring stiffness switching may be controlled based on at least four different parameter logics 502, 504, 506, 508, and each logic has a “hold” logic based on different magnitudes of the rate of change of acceleration (and possibly acceleration). The hold logic 502, 504, 506, 508 may indicate a “minimum decay rate” applied to the magnitude of acceleration or rate of change of acceleration used, to obtain a modified magnitude of acceleration, that may be used to determine if a respective switching threshold is met, to determine when to switch spring stiffness.

The spring stiffness state 536 may be held at high stiffness in dependence on any combination of one or more of these functions/parameters 502, 504, 506, 508. In the illustrated example, the acceleration parameters are shown as being modified according to either the acceleration or rate of change of acceleration as discussed in relation to FIGS. 4a-4c to provide respective spring state requests 522, 526, and the rate of change of acceleration parameters are shown as being modified according to the rate of change of acceleration to provide respective spring state requests 524, 528. That is, the spring state request determined according to the lateral acceleration 502 is determined according to the “held” acceleration 462, which may be obtained dependent on a decay function applied to the lateral acceleration 510 or a decay function applied to the rate of change of lateral acceleration 512; the spring state request determined according to the rate of change of lateral acceleration 504 is determined according to the “held” rate of change of lateral acceleration, which may be obtained dependent on a decay function applied to the rate of change of lateral acceleration 518; the spring state request determined according to the longitudinal acceleration 506 is determined according to the “held” longitudinal acceleration, which may be obtained dependent on a decay function applied to the longitudinal acceleration 514 or a decay function applied to the rate of change of longitudinal acceleration 516; and the spring state request determined according to the rate of change of longitudinal acceleration 508 is determined according to the “held” rate of change of longitudinal acceleration, which may be obtained dependent on a decay function applied to the rate of change of longitudinal acceleration 520.

Also illustrated in this example is a spring state request determined according to a current driving mode 530. For example, the vehicle may be operating in a driving mode (e.g. a Comfort mode, Dynamic mode, or Off-Road mode) which requires a particular spring stiffness mode. A driving mode on a driving track may request high spring stiffness regardless of the rate of change of acceleration to obtain improved handling at speed, for example. This “driving mode” spring state request 530 may also be provided 532. In relation to vehicle driving modes, the control system 100 may be configured to receive an input from a mode selector. The mode selector may be controlled by a user, for example by the driver of the vehicle. The mode selector may be used to alter a relationship between the adjusted acceleration and the acceleration, or the adjusted rate of change of acceleration and the rate of change of acceleration. For example, the mode selector may be used to alter a decay function between the adjusted acceleration and the acceleration or the adjusted rate of change of acceleration and the rate of change of acceleration in some examples (e.g. by providing a “hold” signal 532 requesting maintenance of high spring stiffness). In some examples, the mode selection may act as an override such that a high spring stiffness is maintained for all or a majority of the drive cycle, for example.

Any of the hold threshold, spring stiffness reduction threshold, and spring stiffness increasing threshold discussed above may be set based upon driving conditions and/or based upon the input from the mode selector, in some examples.

The spring state requests 502, 504, 506, 508, 530 are provided 522, 524, 526, 528, 532 to a “maximum” module 534 which may determine which of the provided spring state requests 522, 524, 526, 528, 532 provides the maximum length of time for the spring state to the held at high stiffness. The modified acceleration curve or rate of change of acceleration curve according to this maximum spring state request is provided 536 to a variable spring stiffness controller to maintain the spring stiffness as high stiffness according to the modified acceleration curve or rate of change of acceleration curve.

The above examples consider maintaining a high stiffness state of a variable stiffness spring. A variable stiffness spring may be controlled to switch to a high stiffness state from a low stiffness state according to the rate of change of acceleration. The control system may, in some examples, be further configured to receive the signal indicative of acceleration of the vehicle when the air spring is operating in a low stiffness state during vehicle motion. A spring stiffness increasing condition may be satisfied when the magnitude of the acceleration is above the spring stiffness increasing threshold. The spring stiffness increasing condition may be satisfied when a magnitude of the rate of change of acceleration is above the spring stiffness increasing threshold.

In all the above examples, one variable stiffness spring may be controlled as described, which is associated with a wheel of the vehicle. Respective processes may be performed for each variable stiffness spring (and therefore for each wheel) of the vehicle separately. This may be by the same control system 100 (e.g. wherein a respective controller 110 of the control system 100 performs the determinations for a particular variable stiffness spring/wheel), or there may be dedicated control systems 100 associated with each wheel. Other control system to spring control mappings may be envisaged.

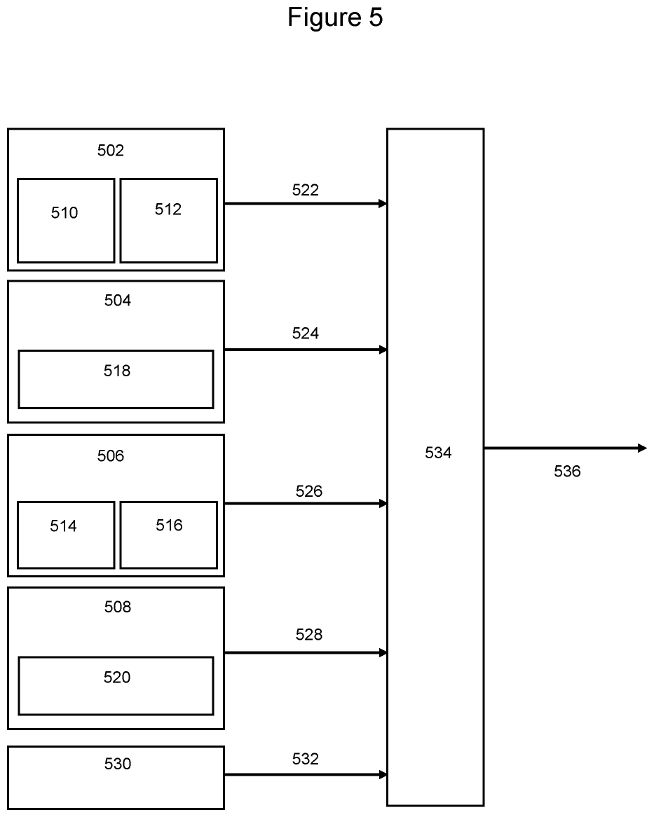

FIG. 6 shows an example method according to examples disclosed herein. The method 600 is a method of operation of a control system for an air spring 250 of a vehicle 700. The method 600 comprises, when the air spring 250 is operating in a high stiffness state during vehicle motion, receiving a signal indicative of a rate of change of acceleration of the vehicle 602. The method 600 comprises determining if a spring state hold condition is satisfied in dependence on the rate of change of acceleration 604. If the spring state hold condition is determined to be satisfied, the method 600 comprises outputting a hold control signal to cause the air spring to remain operating in the high stiffness state 606. As indicated by the loop 610, this method may take place periodically, continuously, or repeatedly in response to a trigger, for example a change in acceleration value exceeding a threshold change in acceleration value.

The method 600 may be performed by the control system 100 illustrated in FIG. 1. In particular, the memory 130 may comprise computer-readable instructions (e.g. computer software) which, when executed by the processor 120 of a control system 100 disclosed herein, perform a method 600 as disclosed herein. Also disclosed herein is a non-transitory, computer-readable storage medium storing instructions thereon that, when executed by one or more electronic processors of a control system 100 as disclosed herein, causes the one or more electronic processors to carry out a method 600 as disclosed herein.

The blocks illustrated in FIG. 6 may represent steps in a method 600 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples.

Also shown in FIG. 6 is a series of steps which may be performed by the control system 100 for the air spring 250 of the vehicle 700. These method steps comprise: when the air spring is operating in a high stiffness state during vehicle motion, receiving a signal indicative of a rate of change of acceleration of the vehicle 612; determining if a spring stiffness reduction condition is satisfied in dependence on the rate of change of acceleration 614; and if the spring stiffness reduction condition is determined to be satisfied, outputting a switch control signal to cause the air spring to switch to operating in a low stiffness state 616. As indicated by the loop 618, these method steps may take place periodically, continuously, or repeatedly in response to a trigger, for example a change in acceleration value exceeding a threshold change in acceleration value.

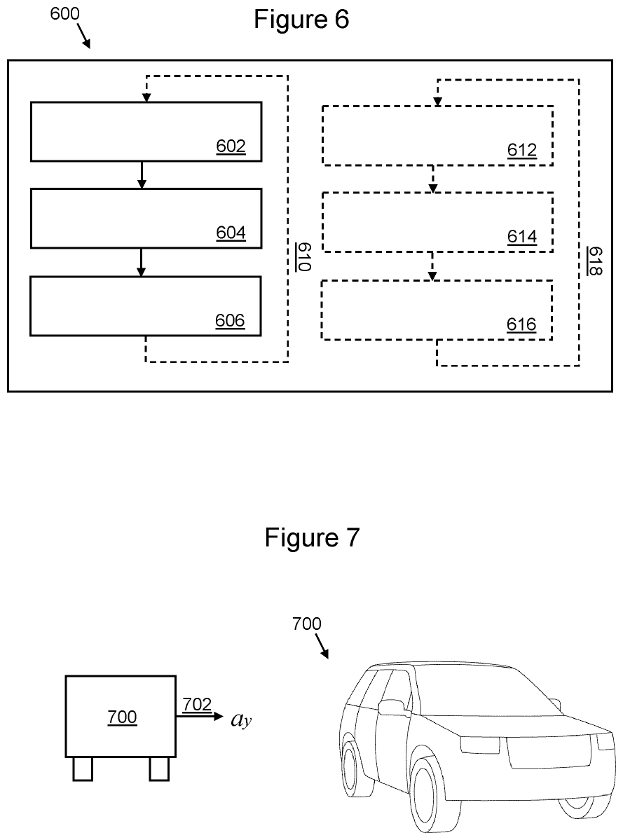

FIG. 7 illustrates an example vehicle 700 according to examples disclosed herein, e.g. comprising a control system 100, or an air spring 250 as disclosed herein. The vehicle 700 in the present embodiment is an automobile, such as a wheeled vehicle, but it will be understood that the control system 100 and vehicle suspension system 300 may be used in other types of suitable vehicle 700. Also illustrated is a schematic front or rear view of a vehicle 700, illustrated the direction of lateral acceleration 702 perpendicular to the direction of forward travel.

As used here, ‘connected’ means either ‘mechanically connected’ or ‘electrically connected’ either directly or indirectly. Connection does not have to be galvanic. Where the control system is concerned, connected means operably coupled to the extent that messages are transmitted and received via the appropriate communication means. The term “control system” may be understood to cover a controller, control module, or control element and need not necessary be a multi-element or distributed system (although it may be in some examples).

It will be appreciated that various changes and modifications can be made to the present disclosed examples without departing from the scope of the present application as defined by the appended claims. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1. A control system for an air spring of a suspension system of a vehicle, the control system comprising one or more controllers, the control system configured to:
when the air spring is operating in a high stiffness state during vehicle motion, receive a signal indicative of a rate of change of acceleration of the vehicle;
determine if a spring state hold condition is satisfied in dependence on the rate of change of acceleration; and
if the spring state hold condition is determined to be satisfied, output a hold control signal to cause the air spring to remain operating in the high stiffness state.

2. The control system according to claim 1, wherein the spring state hold condition is satisfied when a magnitude of an adjusted acceleration is above a hold threshold, wherein the adjusted acceleration is determined in dependence upon the rate of change of acceleration.

3. The control system according to claim 2, wherein the control system is further configured to, when the air spring is operating in the high stiffness state during vehicle motion, receive a signal indicative of an acceleration of the vehicle, the adjusted acceleration being determined also in dependence upon the acceleration.

4. The control system according to claim 3, wherein the magnitude of the adjusted acceleration decays at a slower rate than a corresponding magnitude of the acceleration.

5. The control system according to claim 3, wherein the signal indicative of acceleration comprises at least one signal part, the at least one signal part indicative of one of:
a lateral acceleration of the vehicle; and
a longitudinal acceleration of the vehicle;
wherein the control system is configured to, if the spring state hold condition is determined to be satisfied with respect to any of the at least one signal part, output the hold control signal to cause the air spring to remain operating in the high stiffness state.

6. The control system according to claim 3, wherein the signal indicative of acceleration is based upon an estimated acceleration of the vehicle.

7. The control system of claim 6, wherein the signal indicative of acceleration is based upon an input relating to one or more of:
a steering angle of the vehicle obtained from a user steering wheel input; and
an acceleration of the vehicle obtained from one or more drive pedal inputs.

8. The control system according to claim 2, wherein the magnitude of the adjusted acceleration determined in dependence upon the rate of change of acceleration decays at a slower rate than a corresponding magnitude of the adjusted acceleration determined in dependence upon the acceleration.

9. The control system according to claim 1, wherein the signal indicative of the rate of change of acceleration comprises at least one signal part, the at least one signal part indicative of one of:
a rate of change of lateral acceleration of the vehicle; and
a rate of change of longitudinal acceleration of the vehicle;
wherein the control system is configured to, if the spring state hold condition is determined to be satisfied with respect to any the signal parts, output a hold control signal to cause the air spring to remain operating in the high stiffness state.

10. The control system according to claim 1, wherein the signal indicative of the rate of change of acceleration is based upon an estimated rate of change of acceleration of the vehicle.

11. The control system of claim 10, wherein the signal indicative of the rate of change of acceleration is based upon an input relating to one or more of:
a steering angle of the vehicle obtained from a user steering wheel input; and
an acceleration of the vehicle obtained from one or more drive pedal inputs.

12. A system comprising an air spring and the control system according to claim 1.

13. A vehicle comprising the control system according to claim 1.

14. A method of operating a control system for an air spring of a vehicle, the method comprising:
when the air spring is operating in a high stiffness state during vehicle motion, receiving a signal indicative of a rate of change of acceleration of the vehicle;
determining if a spring state hold condition is satisfied in dependence on the rate of change of acceleration; and
if the spring state hold condition is determined to be satisfied, outputting a hold control signal to cause the air spring to remain operating in the high stiffness state.

15. Computer software which, when executed on a processor of a control system, is arranged to cause the processor to perform the method according to claim 14.

16. A vehicle comprising the system of claim 12.
